(19) United States
(12) Patent Application Publication
(10) Pub. No.: US 2007/0255824 A1
(43) Pub. Date: Nov. 1, 2007

(54) Device for Tapping Userful Data From Multimedia Links in a Packet Network

(76) Inventor: Hermann Granzer, Pocking (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,226

(22) PCT Filed: Aug. 4, 2005
(86) PCT No.: PCT/EP05/53836

§ 371 Date: Feb. 15, 2007

(30) Foreign Application Priority Data
Aug. 20, 2004 (DE) 10 2004 040 454.2

(51) Int. Cl. G06F 15/173

(52) U.S. Cl. 709/224

(57) ABSTRACT

In one aspect, a method for tapping useful data of multimedia data connections in a packet network is provided. Useful data that includes a plurality of subcomponents is provided. One of the subcomponents is separated from the useful data and sent to an interception device. The useful data is transmitted to a receiver.

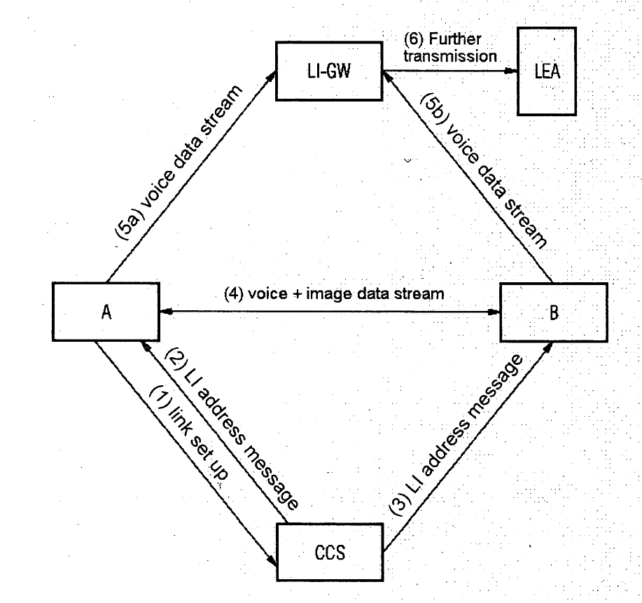

### CROSS REFERENCE TO RELATED APPLICATIONS

This application is the US National Stage of International Application No. PCT/EP2005/053836, filed Aug. 4, 2005 and claims the benefit thereof. The International Application claims the benefits of German application No. 102004040454.2 DE filed Aug. 20, 2004, both of the applications are incorporated by reference herein in their entirety.

### FIELD OF INVENTION

The present invention relates to a device for tapping useful data from multimedia links in a packet network.

### BACKGROUND OF INVENTION

With the increasing spread and use of data-based communication such as Voice-over-IP (VoIP) and Video-over-IP or Multimedia-over-IP (MoIP), regulatory and legislative measures are also increasing in significance. A current example of this is Lawful Interception (LI), referred to below by its abbreviation LI, which is taken to mean the (lawful) interception of telephone calls and also of VoIP (data calls).

This legally prescribed option for intercepting voice data is performed in classical telephone networks in TDM technology. In the packet network the voice data must be routed via a conventional interface into the TDM network where the interception is undertaken in a classical manner using a TDM loop in TDM technology. This means that initially a conversion of for example IP (Internet Protocol) to TDM must be undertaken. Here the tapped voice data is forwarded to the requesting bodies (LEAS, Law Enforcement Agencies), referred to below by their abbreviation LEA. In parallel to this a conversion back into the IP protocol is undertaken, via which the voice data is then routed to the called party.

In the case of video telephony in the packet network the problem which now arises is that of how to tap the mixed useful data stream now made up of voice data and image data. For implementing LI in the packet network it has been suggested that voice and images be separated and handled separately. To this end the voice data is routed out of the packet network via the TDM loop where it is tapped conventionally. The image data by contrast is routed directly via the packet network to the receiver, where the separated voice and image data must be merged again.

The separation in this case is undertaken in the terminal or in a device assigned to the terminal either by creating two separate connections or by issuing two packet addresses within the framework of a single connection.

### SUMMARY OF INVENTION

However the special handling of the two useful data streams has one significant disadvantage. It means that the voice data is subject to an additional delay, especially as a result of the conversion from IP into TDM and back again. By contrast, the image data, which does not undergo this conversion, is thereby also not delayed additionally so that it arrives at the communication end point without any additional delay. Thus voice and image data may no longer be synchronized, the speech lags behind the lip movements for example. A retroactive synchronization in the terminal is not easily possible since the different data streams do not bear any secure time stamps. This means that the end subscriber can even detect that the call is being intercepted. (In the “normal” case without LI, voice and image data arrive together at the terminal so that lip synchronization can be undertaken here by the terminal.

An object of the invention is to specify a method and a device which prevents the interception of communication data of multimedia links being noticed by the end subscriber.

The advantage of the invention is that one or more subcomponents of the useful data are separated from the useful data on the transmit side and routed for the purposes of interception to one or more interception devices, and the useful data is routed directly to the receiver. In this case for example the useful data concerned can be formed from the subcomponents voice data, image data and a data connection, with further subcomponents also being conceivable.

The present invention is described using video telephony as an example. Here the useful video data stream is made up of voice data and image data. The voice data stream is separated from the video data stream and subsequently tapped in the classical manner using the TDM loop. At the same time the video data stream formed from voice data and video data is routed to the receiving subscriber. This guarantees optimum synchronization, since simultaneous voice and image data is also transmitted together and simultaneously. The receiving subscriber thus does not notice the interception. The separation of the voice data is thus undertaken exclusively for the purposes of interception.

The separation of voice data and image data can be undertaken in the terminal itself. This is not mandatory however. Thus the separation can take place in a device assigned to the terminal, such as a set-top box or a proxy server for example. The separation is undertaken in the case of video telephony either by creating two separate connections or by issuing two packet addresses within the framework of a single connection. The particular advantage of the invention can be seen as the fact that the invention is not restricted to a specific protocol or to voice connections/video connections. This means that any transmission protocol or other data connections can be used. If connections with more than two component parts are used, a number of subcomponents must be separated, a number of connections set up, or a number of packet addresses generated within the framework of a connection.

Advantageous developments of the invention are specified in the dependent claims.

### BRIEF DESCRIPTION OF THE DRAWINGS

The invention is explained in greater detail with reference to an exemplary embodiment shown in a FIGURE. Accordingly this shows a configuration using video telephony as an example, with the aid of which the asynchronism between voice and image data stream is eliminated or does not even arise.

### DETAILED DESCRIPTION OF INVENTION

The drawing shows two terminals A, B. The signaling between the two terminals passes via a Call Control Server CCS that can be embodied as a SIP Proxy, H.323 Gatekeeper or Media Gateway Controller. Furthermore the diagram includes a gateway LI-GW with LI functionality as well as LEA devices. Current gateways LI-GW have interfaces to the TDM world where the voice data is tapped. This means that an especially long delay occurs in the prior art. Gateway LI-GW does not however absolutely have to have TDM components and in this case is fully integrated into the IP world. This means that the voice data stream experiences a smaller delay, but this is still perceived by the receiving terminal because of the different paths of the two useful data streams.

It is now proposed that the video data stream formed from the voice/image data stream be transmitted to the called subscriber (4) as in the prior art. In accordance with the invention, the voice data is separated from the video data in the transmit terminal. To this end the Call Control Server CCS notifies the end points (terminals A, B) that they must send the video data stream and the voice data to different destination addresses (2, 3). The corresponding terminal (e.g. a multimedia terminal, a video telephone etc) must of course support this method. The separation in this case can either be performed in the terminal be creating two separate connections or by issuing two packet addresses within the framework of a single connection. The gateway LI-GW is effectively connected to the LEAs to which the intercepted voice data is forwarded (6).

Thus the video data stream (image data and voice data) is exchanged directly over the packet network between the two terminals A, B. At the same time the voice data stream is sent in the transmit terminal on its own once again, and is sent to the destination address for the voice data requested by the Call Control Server CCS. This is the gateway LI-GW. This unit can then, entirely unaffected by possible delays, process the voice data, forward it and process it in other ways. Any delay caused by this is of no importance since the voice data is also transmitted together with the image data to the end subscriber in parallel to this data. Thus even a greater delay in the pure voice data, because of increased load or because of a failure of the gateway LI-GW, is of no significance for communication between the end subscribers.

The gateway LI-GW can optionally forward the received voice data stream to the receiving terminal B (5b). This terminal does not absolutely need the data stream and can ignore it. As a rule the voice data stream will end at the gateway LI-GW.

In a further embodiment of the invention there is provision for duplicating the signaling information and transmitting it to a gateway LI-GW, in order to intercept just the signaling information (i.e. “who is communicating with whom?”), without also recording the useful data (voice, data, file transfer etc.) as well. The advantage associated with this is the greatly reduced data volume. In this case the Call Control Server can establish expanded interception at any time by instructing the terminal even during the connection to transmit specific data to or via the gateway LI-GW.

Naturally this method requires the appropriate support by the terminal. However the Call Controller can use suitable methods to establish that the terminal involved is a trusted and supported terminal, for example through hardware authentication.

In general the data separation can be undertaken by the terminal, an upstream unit (home gateway, set-top box) or also a media gateway. Technically this media gateway can operate either as what is known as a back-to-back user agent, i.e. terminate the call and set up direction B again, or only “extract” the data stream and duplicate it. In this way it is generally possible the intercept the complete communication, that is the voice+video communication, without any delays. The data separation can basically be done at any point in the network (in the media GW, or in a Call Controller which lies in the data path).

1.-8. (canceled)

9. A method for tapping a useful data of a multimedia data connection in a packet network, comprising:
providing the useful data comprising a plurality of subcomponents;
separating one of the subcomponents from the useful data and sending the separated subcomponent to an interception device, and
transmitting the useful data to a receiver,
wherein the separating does not remove the separated subcomponent from the useful data.

10. The method as claimed in claim 9, wherein the separation is done by setting up at least two connections.

11. The method as claimed in claim 9, wherein the separation is done by issuing at least two packet addresses within the framework of a single connection.

12. The method as claimed in claim 9, wherein the separation is done in the terminal.

13. The method as claimed in claim 9, wherein the separation is done in a device assigned to the terminal.

14. The method as claimed in claim 9, wherein the separation is done in any device in the network.

15. The method as claimed in claim 9, wherein the separated subcomponent is voice data.

16. A device for tapping a useful data from multimedia links in a packet network, comprising:
a useful data formed from a plurality of subcomponents;
a separator that creates a first connection to a receiver and a second connection to an interceptor and that separates at least one subcomponent from the useful data; and
a transmitter that transmits the separated component to the interceptor and transmits the useful data to the receiver,
wherein the separator does not remove the separated subcomponent from the useful data.

17. The device as claimed in claim 16, wherein the separated subcomponent is voice data.

18. A device for tapping a useful data from multimedia links in a packet network, comprising:
a useful data formed from a plurality of subcomponents;
a separator that creates a single connection via a plurality of packet addresses and that separates at least one subcomponent from the useful data; and
a transmitter that transmits the separated component to an interceptor and transmits the useful data to a receiver,
wherein the separator does not remove the separated subcomponent from the useful data.

19. The device as claimed in claim 18, wherein the separated subcomponent is voice data.
